(19) United States
(12) Patent Application Publication
(10) Pub. No.: US 2006/0032120 A1
(43) Pub. Date: Feb. 16, 2006

(54) Seed coating composition

(75) Inventor: Roger E. McPherson, Muscatine, IA (US)

Correspondence Address: BANNER & WITCOFF, LTD., TEN SOUTH WACKER DRIVE, SUITE 3000, CHICAGO, IL, 60606, US

(73) Assignee: Grain Processing Corporation, Muscatine, IA (US)

(21) Appl. No.: 10/891,854

(22) Filed: Jul. 15, 2004

(51) Int. Cl. A01C 1/06; A01C 21/00

(52) U.S. Cl. 47/57.6

(57) ABSTRACT

Disclosed is a seed coating composition that includes hemicellulose and a material that is beneficial for the growth of the seed. The beneficial material may be a control agent for a biological entity that is detrimental to the growth of the seed. The control agent may be, for instance, a fungicide, herbicide, or insecticide. Also disclosed is a coated seed, the seed including a coating over at least a portion thereof that comprises hemicellulose and, optionally, a control agent. Methods for preparing such coated seeds and for planting such coated seeds also are disclosed.

### FIELD OF THE INVENTION

The invention is in the field of binders for seed coatings.

### BACKGROUND OF THE INVENTION

Hybrid seed corn and other agronomic seeds are treated commercially before sale by coating them with a film-forming binder. The binder carries chemicals useful to the seed grower and beneficial for the growth of the seeds, such as fungicides, pesticides, herbicides, dyes, and other chemicals. The market for seed binders is substantial; for instance, the current annual U.S. market for the film forming binder for hybrid corn seed alone is around 1,750,000 lbs dry basis.

It can be technically challenging to prepare a suitable seed coating. The seeds must be able to dry satisfactorily after coating with the binder and must not agglomerate.

Whether a coating can be easily or successfully applied often depends on the type of seed. For instance, it is recognized in the industry that corn seeds, which have an impervious waxy seed coat, are among the most difficult seeds to coat successfully.

Additionally, since the seed coating often contains toxic bioactives, it is very important for health and safety reasons that the seed coating does not spall off the seed during handling.

Historically, synthetic latex has been used to coat seeds. Natural and synthetic gums also have found some use as coatings on seeds. Other materials also have been proposed as seed coating binders. For instance, U.S. Pat. Nos. 5,876,739 and 5,849,320 purported to describe polymers and copolymers of methyl cellulose, vinylidene chloride, acrylic, vinyl acetate-ethylene copolymer, cellulose, and polysaccharides as binders for insecticidal seed coatings. U.S. Pat. No. 4,272,417 describes vinyl acrylic emulsions as a binder system for seed coatings. U.S. Pat. No. 5,328,942 teaches seed coating binder compositions containing cellulosic polymers and a polyalkylene oxide polymer. U.S. Pat. No. 5,994,265 purportedly describes uses of polyvinyl alcohol, polyvinyl acetate, and polyvinyl pyrrolidone as binders in seed coating formulations.

U.S. Pat. No. 5,994,265 purportedly describes the use of gum arabic, a natural gum, as a binder in seed coating formulations, and U.S. Pat. No. 6,453,608 B1 purportedly discloses the use of the gellan gum, a cultured gum for this purpose. Likewise, WO 9325078 purportedly describes using a hydrolyzate of either carboxymethylcellulose or carboxymethyl starch as a seed coating binder. U.S. Pat. No. 6,202,346 B1 purportedly describes the uses of molasses, granulated sugar, alginates, karaya gum, jaguar gum, tragcanth gum, polysaccharide gum, and mucilage as binders.

Virtually all synthetic binders have fairly high costs associated with their production.

In addition, some of the foregoing natural occurring binders are produced in unstable areas of the world, thereby creating instability in the source of supply. Often, the isolation of naturally occurring binders relies upon costly purification processes which create waste streams and which often consume finite petroleum reserves. Thus, there is a desire to find effective binders for use as seed coatings that are not expensive to produce relative to other binders, that are less harmful to the environment, and that are readily available.

The present invention seeks to provide a binder for a seed coating composition, and, in other embodiments, seeds that are coated with such binder. In highly preferred embodiments, the invention seeks to provide a binder that is inexpensive and that is available in abundant supply.

### THE INVENTION

It has been found that hemicellulose and hemicellulose-containing compositions derived from grain hulls, in particular corn hulls, can serve as excellent binders for seed coating compositions. Hemicellulose will serve as a carrier for control agents, such as herbicides, fungicides, and insecticides, or other substances beneficial to the growth of the seed in a seed coating composition, and otherwise has excellent properties. Moreover, at present, hemicellulose can be obtained inexpensively.

The invention contemplates, in one embodiment, a coating that is made from a hemicellulose-containing material in conjunction with a material that is beneficial for the growth of the seed. The second material preferably is a control agent for a biological entity that is detrimental to the growth of a seed. The control agent may be, for instance, a fungicide, herbicide, or insecticide, or may be any other suitable control agent. The hemicellulose-containing material is preferably derived from the soluble portion of an alkali digest of cooked corn hulls. This material, which includes starch, proteins, and other components of the hulls, has surprisingly been found superior to more purified forms of hemicellulose.

Also contemplated by the invention is a seed that is coated over at least a portion thereof with hemicellulose, preferably in conjunction with other hull components.

The seed can include multiple coatings, one or both of which coating may include hemicellulose. Thus, for instance, hemicellulose may be provided as an overcoat for a previously treated seed.

The invention further contemplates methods for preparing coated seeds, and methods for planting coated seeds, the seeds being coated in accordance with the present inventive teachings.

These features of the invention will be discussed in more detail hereinbelow, along with further features of preferred embodiments of the invention.

### DETAILED DESCRIPTION OF THE PREFERRED EMBODIMENTS

The invention is contemplated to be applicable to the coating of seeds. “Seeds” is contemplated to be that part of a plant that is capable of germination. The seed ordinarily includes a hard outer shell or natural coat. In some embodiments the seeds used in conjunction with the invention may be untreated seeds, or in other embodiments may be seeds that have been previously treated, such as by applying a coating. Any seed can be treated in accordance with the invention, and seeds for crops such as cereals, vegetables, ornamentals, and fruits are deemed particularly preferred for use in conjunction with the invention. Highly preferred crop seeds are those selected from the group of corn (sweet and field), soybean, wheat, barley, oats, rice, cotton, sunflower, alfalfa, sorghum, rapeseed, sugarbeet, Brassica spp., tomato, bean, carrot, tobacco and flower seed, for example, pansy, impatiens, petunia and geranium. The most highly preferred seeds include corn and soybean seeds.

In accordance with the invention, the seeds are coated with hemicellulose.

Hemicellulose is a component of plants, in particular plant hulls. Hemicellulose can be produced commercially as a byproduct of the grain wet milling industry, particularly the corn wet milling industry. The domestic (U.S.) corn wet milling and dry milling industries produce large annual volumes of corn hulls and bran annually, respectively, and thus hemicellulose obtained from corn hulls or bran is inexpensive.

The domestic U.S. hybrid corn crop is enormous and stable, and the composition of the corn seeds does not vary significantly. Corn crops provide a reliable, low cost, and consistent source of hulls, as well as bran and spent germ, as byproducts from the production of starch, corn flour, protein and oil. The remaining discussion will focus on corn hulls and on hemicellulose prepared therefrom, but it should be understood that hemicellulose obtained from other sources may be used in conjunction with the invention.

A representative compositional analysis of non-destarched commercially produced corn hulls is as follows (corn bran is expected to have a similar composition):

| | |
|---|---|
| Hemicellulose | 56.38% |
| Cellulose | 18.79% |
| Starch | 8.14% |
| Protein | 7.90% |
| Fat | 1.69% |
| Acetic acid | 3.51% |
| Ferulic acid | 2.67% |
| Diferulic acid | 0.58% |
| Coumaric acid | 0.33% |
| Other | (trace) |

The hemicellulose fraction of the hulls is composed of a collection of polysaccharide polymers with a typical lower DP than the cellulose in the plant. Hemicellulose is a polymer that is composed mostly of D-xylopyranyl, D-galactopyranyl, L-arabinofuranyl, and D-glucopyranosyluronic acid units, with minor amounts of other sugar units such as D-glucopyranyl and D-mannopyranyl units. The various forms of hemicellulose and the ratio of hemicellulose to cellulose is not well defined and may vary from plant to plant or from crop to crop within a given plant.

Hemicellulose or a hemicellulose-containing material may be obtained from the hulls in any suitable manner. Procedures to isolate the various components of the corn hulls have been described in the art. These procedures include alkaline cooking of corn hulls, such as the procedures described in U.S. Pat. Nos. 2,801,955; 3,716,526; 2,868,778; and 4,038,481. These documents, in particular U.S. Pat. No. 4,038,481, also describe the isolation of corn hull hemicellulose from corn hulls. The treatment of corn hull hemicellulose with hydrogen peroxide also is taught in the technical literature. The alkaline cooking of corn hulls to produce an adhesive composition upon drying for cellulosic materials is taught in U.S. Pat. Nos. 5,855,659; 5,786,048; 6,063,178; and U.S. Pat. No. 6,179,905 B 1.

Generally, the foregoing techniques yield hemicellulose in an aqueous solution. Any aqueous solution of hemicellulose may be employed in conjunction with the invention, but preferably, the hemicellulose solution is that obtained or derived from the soluble component of the alkali digest of cooked corn hulls. This digest typically will include starch (in an amount of 5 to 25%, but generally at least about 5%); protein, hemicellulose, fatty acid salts; glycerin, acetic acid, ferulic acid, diferulic acid, coumaric acid, and trace amounts of other materials such as phytosytosterols and minerals. While it is not intended to limit the invention to a particular theory, it is believed that the starch and/or the protein are present in an amount effective to enhance film-forming ability. It is further believed that some of the other components of such products are active on the surface of certain seeds (particularly corn seeds, which are waxy) and are present in an amount effective to enhance coatability of the composition.

The solution is preferably concentrated by evaporation of a portion of the liquid to a solids content ranging from 10 to 20% to form a binder for the seeds. If desired, this material can be treated with an α-amylase enzyme prior to concentration and ultrafiltered to remove insoluble components, thus rendering a mixture that includes hemicellulose in a dry basis amount of at least 30%, preferably at least 35%, and a solids content ranging from about 5 to 15%. In either case, the hemicellulose solution may be dried and subsequently reconstituted (for instance, if it is desired to transport large quantities of the material). A non-phytotoxic preserving agent may be added in any suitable amount (typically 0.1-0.3% by dry basis weight). A dried composition having a moisture content of 10% or below and including hemicellulose and a material that is beneficial for the growth of the plant is deemed to be within the purview of the invention.

The hemicellulose-containing composition so obtained may be used as a coating for seeds. In many cases, it will be desired to include other materials in the coating, whereby the coating will function as a carrier for such other materials. Generally, the other material may be a material that is beneficial for the growth of the seeds. Such other materials may be added to the coating prior to application to the seeds, or may be added contemporaneously with the hemicellulose during coating of the seeds.

Typical such materials include control agents, such as insecticides, fungicides, and herbicides. Other materials that may be employed are not per se beneficial to the growth of the seed, but are ingredients that enhance the properties of the binder or facilitate coating of the seeds with the binder. These ingredients may include plasticizers, fillers, and possibly other ingredients, such as colorants.

The control agent may be one or more of insecticides, herbicides, fungicides, herbicidal safeners, or fertilizers. The amount of the control agent in the coating will vary depending on the type of seed and particular active ingredient, but in general will range from about 0.005 to about 50% of the weight of the seed.

Suitable insecticides include, but are not limited, to pyrethoids, organophosphates, caramoyloximes, pyrazoles, amidines, halogenated hydrocarbons, and carbamates and derivatives thereof. Particularly suitable classes of insecticides include organophosphates, phenylpyrazoles and pyrethoids. Preferred insecticides are those know as terbufos, chlorpyrifos, fipronil, chlorethoxyfos, tefluthrin, carbofuran, imidacloprid, and tebupirimfos. Also included are insect growth regulators for example, methoprene and hydroprene. These are well known to those skilled in the art. The insecticide is preferably included in an amount of about 0.01 to about 40%, more preferably in an amount about 0.05 to about 20.0%, based on the weight of the seed.

Suitable examples of fungicides include, but are not limited to, Captan (N-(trichloromethyl)thio-4-cyclohexane-1,2-dicarboximide); Thiram (tetramethylthio-peroxydicarbonic diamide; Metalaxyl (methyl N-(2,6-dimethylphenyl)-N-(methoxyacetyl)-DL-alaninate; Fludioxonil (4-(2,2-difluoro-1,3-benzodioxol-4-yl)-1H-pyrrol-3-carbonitrile; and Oxadixyl (N-(2,6-dimethylphenyl)-2-methoxy-N-(2-oxo-3-oxazolidinyl)acetamide. The selection of the fungicide may depend on the harmful pathogens which are not only a problem for a particular locale where the coated seed is to be grown but also suitable for the protection of seeds in storage before planting.

The amount of fungicide to be added will vary due to the strength of its active ingredient, but in general may range from about 0.001 to about 10% of the weight of the seed and preferably from about 0.01 to about 2.0%.

Suitable herbicides include, but are not limited to, those selected from carbamates, thiocarbamates, acetamides, particularly chloroacetamides, triazines, dinitroanilines, glycerol ethers, pyridazinones, uracils, phenoxys, ureas, and benzoic acids and derivatives. Suitable safeners include, for example, benzoxazine, benzhydryl derivatives, N,N-diallyl dichloroacetamide, various dihaloacyl, oxazolidinyl and thiazolidinyl compounds, ethanone, naphthalic anhydride compounds, and oxime derivatives.

Other suitable control agents include, but are not limited to, agents for the control of bacteria of the genera Rhizobium, Bacillus, Pseudomonas, and Serratia, fungi of the genera Trichoderma, Glomus, and Gliocladium and mycorrhizal fungi.

The coating composition also may include a plasticizer. Plasticizers are typically used to make the film that is formed by the coating layer more flexible, to improve adhesion and spreadablity, and to improve processing. The improved film flexibility can reduce chipping, breakage and flaking during handling or seed sowing processes.

Any suitable plasticizer may be used. Preferred plasticizers include polyethylene glycol, glycerol, butylbenzylphthalate, glycol benzoates and related compounds. The plasticizer may be used in any amount effective to render the final seed coating more flexible than that of an otherwise similar coating prepared in the absence of the plasticizer. The range of the percent of plasticizer in the coating layer typically will be in the range of about 0.1 to about 20%.

If desired, the coating may include one or more fillers. Fillers include, but are not limited to, wood flours, clays, activated carbon, carbohydrates, diatomaceous earth, cereal flours, fine-grain inorganic solids, calcium carbonate and the like. Clays and inorganic solids which may be used include calcium bentonite, kaolin, china clay, talc, perlite, mica, vermiculite, silicas, quartz powder, montmorillonite and mixtures thereof. Suitable carbohydrate fillers include sugars, dextrins, and maltodextrins.

Suitable cereal flours include wheat flour, oat flour and barley flour. Preferred fillers include perlite, silica and calcium carbonates and mixtures thereof, depending upon the type of seed and on the particular bioactive control agent.

The amount of filler used may vary, but generally the weight of the filler components will be in the range of about 0.005 to about 70% of the seed weight, more preferably about 0.01 to about 45% and most preferably about 0.1 to about 15%.

To prepare the coating composition, generally the various ingredients that comprise the coating should be blended. This is deemed to include blending of the composition by adding one or more components during the step of applying the coating to the seeds. Otherwise, no special apparatus or blending conditions are contemplated.

The viscosity of the present seed-coating compositions at application is typically between about 300 and 2000 centipoise at 25° C., with a preferred performance viscosity of about 900 centipoise. The effective amount of seed coating composition per 100 pounds of seeds may range between 4 and 8 ounces.

Conventional or otherwise suitable coating equipment or techniques may be used to coat the seeds. Suitable equipment is deemed to include drum coaters, fluidized beds and spouted beds, but any suitable equipment or technique may be employed.

Additionally, various coating machines are available to one skilled in the art. The seeds may be pre-sized prior to coating. After coating, the seeds are dried to a moisture content sufficiently low to provide a coating on the seeds. When plural seeds are coated, the moisture content should be sufficiently low, and the other properties of the coating otherwise should be adequate, to provide discrete plural seeds that are not agglomerated. After coating, the seeds then optionally may be sized by transfer to a sizing machine, which may be conventional or otherwise suitable. The binder is preferably provided in sufficient quantity to provide a coating on the seed that contains hemicellulose in an amount of from about 0.01 to about 15% by weight of the seed, more preferably, about 0.1 to about 10% by weight of the seed, excluding bioactives contained in the coating.

A film overcoat can be optionally applied to the coated seeds of the present invention.

The film overcoat protects the coating layers and optionally allows for easy identification of the treated seeds. Such overcoats are known and within the skill of the art. The overcoat may be another hemicellulose coating or may be a conventional coating. The invention is contemplated to encompass seeds that contain a first conventional coating and an overcoat that comprises hemicellulose.

The following Examples illustrate, but do not limit, the invention.

### EXAMPLE 1

Binder Prepared by Jet-Cooking Commercial Corn Hulls with NaOH

Dried corn hulls from a corn wet milling process of US Number 2 grade hybrid yellow corn were ground to a fine flour and assayed to contain 6.2% moisture, 7.88% dry basis protein, 11.2% dry basis starch, and 4.65% dry basis fat. The ground corn hulls, 833 g dry basis, were placed into 9,000 g tap water to form a slurry. NaOH (64.0 g) was added and the pH was measured to be 11.95.

The resulting slurry was continuously jet-cooked in a continuous jet cooker equipped with a Hydroheater Combining Tube which inflicted high shear into the slurry at the point of contact with high pressure steam at ˜150 psig. The jet-cooking conditions were as follows: Temperature=315° F. to 325° F., Pressure=˜70 psig, Time=12.6 minutes.

The pH of the paste of the alkaline cooked corn hulls was adjusted to 4.1 with phosphoric acid, and the paste was then filtered across a vacuum filter which had been precoated with a diatomaceous earth filter aid in order to remove insolubles. The filtrate, which was composed of an aqueous solution of hemicellulose, starch, protein fragments, fatty acid salts, glycerin, acetic acid, ferulic acid, diferulic acid, coumaric acid, and trace amounts of other materials such as phytosytosterols and minerals, was recovered and concentrated to a syrup having a solids of 14.8% by vacuum evaporation. The product was analyzed and found to have the following partial composition.

| Sample Description | Product of Example 1 |
|---|---|
| % Solids | 14.82% |
| % (d.b.) Corn Hull Hemicellulose | 36.71% |
| % (d.b.) Starch | 12.10% |
| % (d.b.) Protein | 2.41% |
| % (d.b.) Ash | 33.95% |
| μg/g (d.b.) Acetic acid | 5035 |
| μg/g (d.b.) Glycerin | 817 |
| μg/g (d.b.) Xylose | 47 |
| μg/g (d.b.) Arabinose | 1119 |
| μg/g (d.b.) Galactose | 55 |
| μg/g (d.b.) Glucuronic acid | None detected |
| μg/g (d.b.) Ca | 6266 |
| μg/g (d.b.) Na | 74367 |
| μg/g (d.b.) Carbonate | |
| μg/g (d.b.) Ferulic | 11257 |
| μg/g (d.b.) Coumaric acid | 1472 |
| μg/g (d.b.) Phosphate | 270862 |
| μg/g (d.b.) Sulfate | 7821 |

### EXAMPLE 2

Corn Hull Hemicellulose Binder Isolated from the Product Prepared by Jet-Cooking Commercial Corn Hulls with NaOH

Corn hulls from a commercial corn wet milling process, 105 pounds, were added to 215 gallons water. Twenty pounds of 50% NaOH was added. The alkaline slurry thus formed was continuously jet-cooked with a retention time of 15.8 minutes at 280-285° F., 60-70 psig. The pH of the alkaline slurry of cooked corn hulls was adjusted to 4.1 with phosphoric acid, and the slurry was then centrifuged in order to remove insolubles.

The alkaline centrifugate was composed of an aqueous solution of hemicellulose, starch, protein fragments, fatty acid salts, glycerin, acetic acid, ferulic acid, diferulic acid, coumaric acid, and trace amounts of other materials such as phytosytosterols and minerals. The pH of this centrifugate was adjusted to 5.75 with 50% NaOH, and the centrifugate was digested with α-amylase for two hours at 180-185° F.

The resulting digest was ultrafiltered to thereby reduce significantly the amounts of starch fragments, protein fragments, fatty acid salts, glycerin, acetic acid, ferulic acid, diferulic acid, coumaric acid, and other materials and concentrated to a syrup having a solids of 10.2% by vacuum evaporation. The product was analyzed and found to have the following partial composition.

| Sample Description | Product of Example 1 |
|---|---|
| % Solids | 10.20% |
| % (d.b.) Corn Hull Hemicellulose | 91.0% |
| % (d.b.) Starch | 1.1% |
| % (d.b.) Protein | 2.41% |
| % (d.b.) Ash | 3.52% |
| μg/g (d.b.) Acetic acid | 0 |
| μg/g (d.b.) Glycerin | |
| μg/g (d.b.) Xylose | |
| μg/g (d.b.) Arabinose | 13.6 |
| μg/g (d.b.) Galactose | 18.1 |
| μg/g (d.b.) Glucuronic acid | |
| μg/g (d.b.) Ca | 15384 |
| μg/g (d.b.) Na | 1052 |
| μg/g (d.b.) Carbonate | 18137 |
| μg/g (d.b.) Ferulic | 3.6 |
| μg/g (d.b.) Coumaric acid | 0 |
| μg/g (d.b.) Phosphate | 6812 |
| μg/g (d.b.) Sulfate | |

### EXAMPLE 3

Treatment of Previously Untreated Seed

The product of Example 1 and the product of Example 2 were successfully used to coat previously untreated hybrid seed corn and previously untreated hybrid soybean seed.

Seed Coating Results

Fluidized Bed Seed Coating Experiments

A lab-sized fluidized bed coater was used to treat 200 g of previously untreated hybrid seed at a time. In separate batches, the seed coatings of Examples 1 and 2 were pumped as syrups through a peristaltic pump into the center of the bottom of the fluidized mass of seeds. Heated air at 40° C. was used to suspend the mass of seeds.

Flows of syrups were controlled to avoid agglomeration of the masses of seeds. The seed coating was applied at a level of 0.5% dry basis coating on the seeds which equaled 200×0.005=1.0 g for the experiments listed in the table below. The coatings were diluted to this level to provide a viscosity that was sufficiently low to allow for pumping and spraying. Solids of the coating were adjusted with water to provide satisfactory handling. The coated seeds exited the dryer dry to the touch and not sticky on the surface.

| | Original | Solids at | Observations |
|---|---|---|---|
| Coating | Solids | which used | and Conclusions |
| Product of | 14.82% | 7.5% | Better performer on corn seed giving |
| Example 1 | | | least amount of flaking of dried |
| | | | coating. Satisfactory performance |
| | | | on soybean seed. |
| Product of | 9.94% | 5.0% | Significant amount of flaking off of |
| Example 2 | | | corn seed. Satisfactory performance |
| | | | for soybean seed. |

Rotating Drum Seed Coating Experiments

In a rotating drum batch coating apparatus 2,000 g of seeds were set to tumbling in the 24″ diameter drum. In separate batches, the coatings of Examples 1 and 2 were sprayed onto the seeds via a compressed air spray gun onto the seeds at 0.5% of the weight of the seeds on a dry weight basis. The coating was dried by a flow of heated air. No handling difficulties were encountered during pumping, spraying, and drying. After storage for three days, both coatings remained well stuck onto soybeans, but only the product of Example 1 was still adhered well onto corn seeds.

| | % Solids of | | Visual Appearance of |
|---|---|---|---|
| | Applied | | Adhesion to Seed Coat |
| Identity | Syrup | Seed | after 3 days |
| Product of Example 1 | 7.41 | Corn | Good |
| Product of Example 1 | 7.41 | Soybean | Good |
| Product of Example 2 | 4.97 | Corn | Poor |
| Product of Example 2 | 4.97 | Soybean | Good |

Germination Results

In evaluating germination, 20 g of the seeds were applied to a stack of ten paper towels, and 60 ml water was added. The towels were folded over onto the seeds, and the seeds were stored in a watertight bag at 69° F. The experiment was repeated, both runs employing seeds coated with the product of Example 1.

All of the seeds germinated very well. There were no apparent toxicities from either the coating or the processing of the seeds.

Fluidized Bed Corn Seeds

| | Germination | Shoot | Root |
|---|---|---|---|
| Coating Identity | Percentage | mg/seedling | mg/seedling |
| None (control) | 98 | 21.65 | 8.35 |
| Product of Example 1 | 99 | 25.1 | 8.9 |
| Product of Example 1 | 99 | 25.4 | 8.7 |

Fluidized Bed Soybean Seeds

| | Germination | Shoot |
|---|---|---|
| Coating Identity | Percentage | mg/seedling |
| None (control) | 77 | 33.8 |
| Product of Example 1 | 81 | 37.6 |
| Product of Example 1 | 72 | 35.8 |

Rotating Drum Corn Seeds

| | Germination | Shoot | Root |
|---|---|---|---|
| Coating Identity | Percentage | mg/seedling | mg/seedling |
| None (control) | 98 | 21.6 | 8.4 |
| Product of Example 1 | 99 | 23.0 | 8.3 |
| Product of Example 1 | 99 | 23.5 | 8.8 |

Rotating Drum Soybean Seeds

| | Germination | Shoot |
|---|---|---|
| Coating Identity | Percentage | mg/seedling |
| None (control) | 77 | 33.8 |
| Product of Example 1 | 76 | 35.7 |
| Product of Example 1 | 99 | 38.3 |

### EXAMPLE 4

Treatment of Previously Treated Seeds

The product of Example 1 and the product of Example 2 were successfully used to coat previously treated hybrid corn seeds and previously treated hybrid soybean seeds.

Seed Coating Results

Rotating Drum Seed Coating Experiments

A seed coater was fabricated by placing a rib-sided two bushel basket on a motorized candy coater made to rotate at 60 rpm. The apparatus resembled a portable concrete mixer. 1000 g of already commercially treated seed (corn seed: Syngenta Seeds, Inc., Minneapolis, Minn., Hybrid=N60-N2; 221081, lot number=628725, which was coated with a proprietary coating) was set to tumbling, and 50 g of a 10% solution of the product of Example 1 was sprayed onto the seeds to give 0.5% of the product of Example 1 on the seeds. The damp sticky seeds were spread out on paper and allowed to air dry overnight with occasional stirring.

The process was repeated using 100 g of the product of Example 1 (1.0% on the seeds). The process was again repeated using that 100 g of a 5.0% solution of the product of Example 2 (0.5% on the seeds), and repeated again using 200 g of a 5.0% solution of the product of Example 2 (1.0% on the seeds).

All four of the air dried-coated corn seeds appeared to have satisfactory coatings. The coatings did not spall off with handling.

Germination Results

When the coated seeds were subjected to germination testing, there was no apparent inhibition of the germination of hybrid corn seed compared to the controls.

Procedure: 10 paper towels with 5 tissue wipes on top were placed in center of tray. 100 corn seeds were placed as a control in a 10×10 array using above bed plot. 60 mL of cold tap water were added to the bed plot via a 25 mL serological pipette while avoiding direct flow onto the corn seeds. The tray was placed into a plastic bag on an oven rack. The end of the plastic bag was twisted and held thusly with a rubber band in order to seal it. The process was repeated in duplicate using corn seeds coated with 0.5% coating and in duplicate using corn seeds coated with 1.0% coating. The seed bed trays were left on oven racks on the countertop at 69° F. A census of each tray was conducted periodically in order to determine percentage of sprouted seeds. The averages of the duplicated tests were tabulated in the following tables.

Product of Example 1

| | 17 Hrs | 41 Hrs | 49 hrs | | | |
|---|---|---|---|---|---|---|
| | % | % | % | 66.5 Hrs | 90 Hrs | 163.5 Hrs |
| | Sprouts | Sprouts | Sprouts | % Sprouts | % Sprouts | % Sprouts |
| Control | 0 | 0 | 0 | 30 | 82 | 99 |
| 0.0% | | | | | | |
| 0.5% | 0 | 0 | 0 | 35 | 77 | 99 |
| 0.5% | 0 | 0 | 0 | 43 | 78 | 100 |
| 1.0% | 0 | 0 | 0 | 36 | 82 | 99 |
| 1.0% | 0 | 0 | 0 | 26 | 65 | 98 |

Product of Example 2

| | ˜48 Hours | ˜72 Hours | ˜90 hours | ˜162 hours |
|---|---|---|---|---|
| | % Sprouts | % Sprouts | % Sprouts | % Sprouts |
| Control 0.0% | 0 | 41 | 73 | 98 |
| 0.5% | 0 | 43 | 75 | 100 |
| 0.5% | 0 | 35 | 85 | 100 |
| 1.0% | 0 | 58 | 79 | 98 |
| 2.0% | 0 | 39 | 82 | 100 |

It is thus seen that hemicellulose can function as a seed coating composition, and in particular can serve as a carrier for bioactive compounds and other materials that are desirably included in a seed coating composition.

While the invention has been described with respect to specific examples including presently preferred modes of carrying out the invention, those skilled in the art will appreciate that there are numerous variations and permutations of the above described systems and techniques.

All references cited herein are hereby incorporated by reference in their entireties.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention. No language in the specification should be construed as indicating that any non-claimed element is essential to the practice of the invention.

Preferred embodiments of this invention are described herein, including the best mode known to the inventors for carrying out the invention. Variations of those preferred embodiments may become apparent to those of ordinary skill in the art upon reading the foregoing description. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A seed coating composition comprising an aqueous solution of hemicellulose and a control agent, said hemicellulose being present in an amount effective to form a coating on a seed, said control agent being an agent for control of a biological entity that is detrimental to the growth of a seed.

2. A composition according to claim 1, said control agent comprising a fungicide.

3. A composition according to claim 1, said control agent comprising a herbicide.

4. A composition according to claim 1, said control agent comprising an insecticide.

5. A composition according to claim 1, said aqueous solution of hemicellulose being derived from an aqueous liquid obtained by of cooking a grain hull with alkali.

6. A composition according to claim 5, said aqueous solution of hemicellulose being derived from corn hulls.

7. A composition according to claim 5, said composition including starch in an amount of at least 5% by dry basis weight.

8. A composition according to claim 5, said composition including at least 30% hemicellulose by dry basis weight.

9. A composition according to claim 5, said aqueous solution of hemicellulose being derived from an aqueous liquid obtained from cooking corn hulls to form an aqueous solution and subsequently evaporating a portion of the moisture from said aqueous solution.

10. A composition according to claim 1, said composition further including a plasticizer in an amount effective to impart flexibility to a film formed from said composition.

11. A composition according to claim 1, said composition including a filler.

12. A coated seed, said coated seed comprising a seed having a coating disposed over at least a portion thereof, said coating comprising hemicellulose.

13. A coated seed according to claim 12, said coating further comprising a control agent, said control agent being an agent for control of a biological entity that is detrimental to the growth of said seed.

14. A coated seed according to claim 13, said control agent comprising a fungicide.

15. A coated seed according to claim 13, said control agent comprising a herbicide.

16. A coated seed according to claim 13, said control agent comprising an insecticide.

17. A coated seed according to claim 12, said hemicellulose being derived from an aqueous liquid obtained by cooking a grain hull with alkali.

18. A method according to claim 17, said hemicellulose being derived from corn hulls.

19. A method according to claim 17, said composition including starch in an amount of at least 5% by dry basis weight.

20. A coated seed according to claim 17, said composition including at least 30% hemicellulose by dry basis weight.

21. A coated seed according to claim 17, said hemicellulose being derived from an aqueous liquid obtained by cooking corn hulls to form an aqueous solution and subsequently evaporating a portion of the moisture from said aqueous solution.

22. A coated seed according to claim 12, said coating further including a plasticizer in an amount effective to impart flexibility to said coating.

23. A coated seed according to claim 12, said coating including a filler.

24. A coated seed according to claim 12, said coating being present on said seed in an amount ranging from about 0.01 to 15% by weight of the seed.

25. A coated seed according to claim 12, said control agent being present on said seed in an amount ranging from about 0.005% to 50% by weight of the seed.

26. A coated seed according to claim 12, said seed comprising a corn seed.

27. A coated seed according to claim 12, said seed comprising a soybean seed.

28. A coated seed according to claim 12, further including a second coating.

29. A coated seed according to claim 28, said second coating comprising hemicellulose.

30. A coated seed according to claim 12, said coating of hemicellulose comprising a second coating disposed over a first inner coating on said seed.

31. A method for preparing a coated seed, comprising providing a seed, providing an aqueous hemicellulose-containing composition, applying said aqueous hemicellulose-containing composition to said seed, and drying said composition to a sufficiently low moisture content to thereby form a coated seed, said seed being coated over at least a portion thereof with said hemicellulose.

32. A method according to claim 31, said composition being applied to said seed in a rotary drum coater.

33. A method according to claim 32, said coating containing a control agent, said control agent being an agent for control of a biological entity that is detrimental to the growth of said seed.

34. A method according to claim 31, said control agent comprising a fungicide.

35. A method according to claim 31, said control agent comprising a herbicide.

36. A method according to claim 31, said control agent comprising an insecticide.

37. A method according to claim 31, said hemicellulose-containing composition being derived from an aqueous liquid obtained by cooking a grain hull with alkali.

38. A method according to claim 37, said hemicellulose-containing composition being derived from corn hulls.

39. A method according to claim 37, said composition including starch in an amount of at least 5% by dry basis weight.

40. A method according to claim 37, said composition including at least 30% hemicellulose by dry basis weight.

41. A method according to claim 37, said hemicellulose-containing composition being derived from an aqueous liquid obtained from cooking corn hulls to form an aqueous solution and subsequently evaporating a portion of the moisture from said aqueous solution.

42. A method according to claim 31, said coating further including a plasticizer in an amount effective to impart flexibility to said coating.

43. A method according to claim 31, said coating further including a filler.

44. A method for planting a seed, comprising providing a seed that is coated over at least a portion thereof with hemicellulose, and planting said seed in a medium suitable for germination of said seed.

45. A method according to claim 44, said medium comprising soil.

46. A method according to claim 44, said coating containing a control agent, said control agent being an agent for control of a biological entity that is detrimental to the growth of said seed.

47. A method according to claim 46, said control agent comprising a fungicide.

48. A method according to claim 46, said control agent comprising a herbicide.

49. A method according to claim 46, said control agent comprising an insecticide.

50. A method according to claim 44, said hemicellulose being derived from an aqueous liquid obtained by cooking a grain hull with alkali.

51. A method according to claim 50, said hemicellulose being derived from corn hulls.

52. A method according to claim 50, said composition including starch in an amount of at least 5% by dry basis weight.

53. A method according to claim 50, said composition including at least 30% hemicellulose by dry basis weight.

54. A method according to claim 50, said hemicellulose being derived from an aqueous liquid obtained by cooking corn hulls to form an aqueous solution and subsequently evaporating a portion of the moisture from said aqueous solution.

55. A method according to claim 44, said coating further including a plasticizer in an amount effective to impart flexibility to said coating.

56. A method according to claim 44, said coating further including a filler.

57. A hemicellulose composition comprising hemicellulose and a control agent for a biological entity that is detrimental to the growth of a seed, said composition having a moisture content of less than 10% by total weight.

58. A composition according to claim 57, said control agent comprising a fungicide.

59. A composition according to claim 57, said control agent comprising a herbicide.

60. A composition according to claim 57, said control agent comprising an insecticide.

61. A composition according to claim 57, said hemicellulose being derived from an aqueous liquid obtained by cooking a grain hull with alkali.

62. A composition according to claim 61, said composition being derived from corn hulls.

63. A composition according to claim 61, said composition including starch in an amount of at least 5% by dry basis weight.

64. A composition according to claim 61, said composition including at least 30% hemicellulose by dry basis weight.

65. A composition according to claim 61, said hemicellulose composition being derived from an aqueous liquid obtained by cooking corn hulls to form an aqueous solution and subsequently evaporating a portion of the moisture from said aqueous solution.

66. A composition according to claim 57, said composition further including a plasticizer in an amount effective to impart flexibility to a film formed from said composition.

67. A composition according to claim 57, said composition including a filler.

68. A coated seed, said coated seed comprising a seed having a coating disposed over at least a portion thereof, said coating comprising hemicellulose and a second material, said second material being a material that is beneficial for the growth of the seed.
